(19) United States
(12) Patent Application Publication
(10) Pub. No.: US 2005/0082935 A1
(43) Pub. Date: Apr. 21, 2005

(54) Electrical machine whose rotor has a ferromagnetic pole core

(75) Inventors: Michael Frank, Uttenreuth (DE); Adolf Kuhn, Rothenbach (DE); Peter Van Hasselt, Erlangen (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellshcaft, Munich (DE)

(21) Appl. No.: 10/903,485

(22) Filed: Aug. 2, 2004

(30) Foreign Application Priority Data
Aug. 1, 2003 (DE) 10335040.3

(51) Int. Cl. H02K 9/00; H02K 1/00; H02K 1/22

(52) U.S. Cl. 310/216; 310/261; 310/52

(57) ABSTRACT

The machine has a rotor with a ferromagnetic pole core, which is fitted with a winding arrangement composed of high-T_{c} superconductor material and surrounds a central internal area, via which the cooling power must be provided in order to cool the winding arrangement. In order to thermally couple the winding arrangement to the internal area, the pole core is composed of a material which contains at least 70% by weight of nickel, and preferably pure nickel.

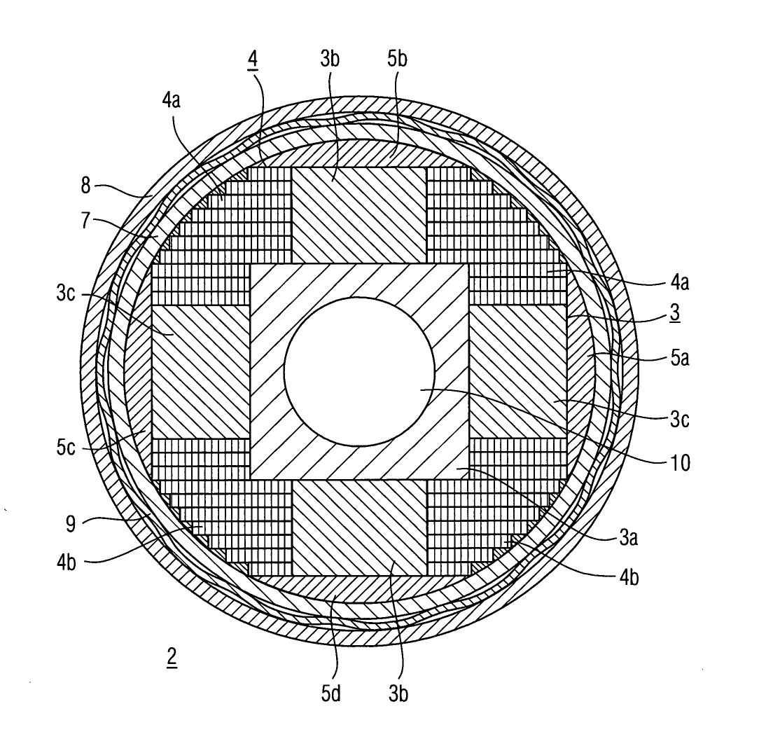

### CROSS REFERENCE TO RELATED APPLICATIONS

This application is based on and hereby claims priority to German Application No. 10335040.3 filed on Aug. 1, 2003, the contents of which are hereby incorporated by reference.

### BACKGROUND OF THE INVENTION

One aspect of the invention relates to an electrical machine
having a rotor which is mounted such that it can rotate about a rotation axis and has a ferromagnetic pole core, which
α) is provided with a superconducting winding arrangement which must be cooled and whose conductors are composed of high-Tc superconductor material, and
β) surrounds a central internal area, via which the cooling power must be provided for cooling the winding arrangement, and,
having a thermal coupling between the superconducting winding arrangement and the internal area.

An electrical machine such as this is disclosed in WO 01/20756 A1.

In superconducting machines such as synchronous machine, a ferromagnetic pole core is often used in order to increase the usable magnetic field. In this case, in particular, a special alloy known as “X8Ni9” is used as the material for the pole core (see WO 02/31949 A1). This alloy has the advantage of high permeability while at the same time being ductile even at the cryogenic operating temperatures required for high-temperature superconducting (HTS) technology. The poor thermal conductivity of this special alloy makes it necessary, however, to use additional highly thermally conductive connections in order to cool the superconducting winding. Furthermore, in order to avoid any distortion of a pole core care must be taken to ensure that it is also itself cooled as uniformly as possible. In the machine which is known from WO 01/20756 A1, cited initially, special radial cooling channels are therefore provided between a central internal area, which is used to accommodate a medium which cools the superconducting winding, and the area of the winding.

The cooling power can also be provided in the central internal area by a heat transmission body which projects as a cooling finger or heat bus into the central internal area. In this case a further conductive mechanism is also required for thermal coupling of the superconducting winding to the cold internal area in the pole core.

### SUMMARY OF THE INVENTION

One possible object of the present invention is to refine the machine having the features mentioned initially so as to reduce the cooling complexity for cooling the superconducting winding.

The inventors propose a pole core composed of a material which contains at least 70% by weight of nickel (Ni).

The advantages associated with the use of this material are, in particular, that the pole core material
1. is sufficiently ferromagnetic for field generation,
2. is sufficiently compatible with low temperature, that is to say it is ductile and is not brittle and
3. is sufficiently highly thermally conductive.

All of these characteristics are provided by a nickel alloy with the stated nickel content. It is particularly advantageous to use pure nickel. The thermal conductivity of nickel is admittedly only about 20% of that of copper. However, since the entire pole core, which is preferably manufactured from one piece, may be used as a heat bus, the thermal conductivity is sufficient on account of the large crossection area available for adequate thermal coupling of the superconducting winding to the central internal area via which the cooling power is provided. Owing to the direct thermal coupling of the the HTS-winding to the central internal area, the individual parts which were previously required for heat transmission in previously known embodiments of HTS-rotors are no longer required. Furthermore, the design, manufacture and assembly are simplified. The savings associated with this are far greater than the increased material costs of the nickel material in comparison to the known X8Ni9-alloy.

From the design point of view, it is particularly advantageous that the currently numerous apertures from the central internal area outward towards the superconducting winding arrangement may be avoided and, furthermore, the central internal area may have a smaller diameter. Furthermore, any mechanical weakening of the pole core associated with this is reduced, and this also makes it possible to reduce eigen-resonance problems.

### BRIEF DESCRIPTION OF THE DRAWING

The invention will be explained in more detail in the following text using one preferred embodiment and with reference to the drawing. In this case, the single figure of the drawing shows a cross section through the rotor of a machine according to one embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The machine rotor, which is annotated 2 in the figure contains a pole core 3 which is used as a winding for a former superconducting winding arrangement 4. According to the exemplary embodiment, this winding arrangement is composed of two coil elements 4a and 4b (see WO 01/20756 A1 as cited). The coil elements are of the so-called racetrack-type and are formed from one of the known HTS materials, such as (Bi, Pb)-Cuprat.

As assumed in the exemplary embodiment the pole core 3 may be composed of two or more parts. For example, it may have a central core part 3a, two core parts 3b surrounded by the coil elements 4a and 4b, and a core part 3c between the coil elements.

The figure also shows four caps with a cross section like a circular segment, by which the coil elements 4a and 4b are attached to the pole core 3. The cylindrical envelope surface which surrounds the winding arrangement 4 and the caps 5a to 5d is defined, for example, by an inner tube 7. Within this inner tube, which may be formed by a special sleeve tube, the parts enclosed by it may be encapsulated by a plastic which can be cured. Since the inner tube 7 is in general at low temperature in the same way as the winding arrangement which surrounds it and is composed of the coil elements 4a and 4b, it may be concentrically surrounded, for example, by an outer tube 8 at room temperature, with the space between the outer tube and inner tube also been provided with insulation 9, such as insulation sheets and/or a vacuum, in order to thermally isolate them.

The pole core 3 together with its core parts 3a to 3c should be composed of a basic nickel alloy with a high nickel content and containing at least 70% by weight of nickel. It is advantageous to provide an even higher nickel content of at least 80% by weight and preferably of at least 90% by weight of nickel. It is particularly advantageous to plan to use a material for the pole core 3 which is referred to as pure nickel.

A material such as this has a nickel content of more than 99% by weight, although, of course, all the materials mentioned above include unavoidable impurity elements. This is because an alloy such as this and, preferably the pure material, are distinguished in that they allow sufficiently good thermal coupling for the superconducting winding arrangement 4 via the pole core 3 for the required cooling power. Thus, for example at 77 K, pure nickel has a thermal conductivity coefficient λ of 4 W/cm degrees depending on the purity level (see, for example, “Gmelins Handbuch der Anorganischen Chemie” (“Gmelins Manual of Inorganic Chemistry”) 8th edition, “Nickel”, part All—Issue 1, Weinheim (DE), 1967, page 316).

One example of suitable alloys is special nickel/iron alloy with a nickel content of more than 70% by weight, in particular special nickel/iron/molybdenum alloys (see “Materials Science and Technology”, [Ed.: R. W. Cahn et al.], Vol. 8 (Structure and Properties of Nonferrous Alloys), VCH-Verlagsgesellschaft, Weinheim (DE), 1996, pages 347 to 399, in particular pages 385 to 389).

The cooling power which is required for cooling of the superconductor material of the winding arrangement is provided in the region of the central internal area 10 within the pole core 3 or the central pole core part 3a. According to one preferred embodiment the internal area 10 may be produced by a hole in the core part 3a. The cooling power is provided, for example, by a cryogenic medium, which can be introduced from the outside into the rotor 2 or its internal area 10, such as LN₂ or LNe in which case the internal area 10 may be at least partly filled with the medium (see, for example, WO 02/43224 A1). However, it is also possible for a highly thermally conductive body to project into the internal area 10 effectively as a cooling finger, which is itself cooled (see, for example, WO 02/15370 A1).

The above exemplary embodiment was based on the assumption that the pole core 3 is composed of two or more core parts 3a to 3c. It is particularly advantageous that the pole core for the machine may also be formed integrally.

1-6. (canceled)

7. An electrical rotor, comprising:
a ferromagnetic pole core having formed of a material which contains at least 70% by weight nickel;
a superconducting winding formed of a high-T_{c} superconductor material; and
a central internal area, from which heat is removed, to cool the superconducting winding, the superconducting winding being thermally coupled to the central internal area.

8. The rotor as claimed in claim 7, wherein the pole core is formed of a nickel alloy, containing at least 80% by weight nickel.

9. The rotor as claimed in claim 7, wherein the pole core is formed of a nickel alloy, containing at least 90% by weight nickel.

10. The rotor as claimed in claim 7, wherein the pole core consists of pure nickel containing at least 99% weight nickel.

11. The rotor as claimed in claim 7, wherein the pole core is formed of two or more core parts.

12. The rotor as claimed in claim 11, wherein the core parts are integral.

13. The rotor as claimed in claim 7, wherein the central internal area is a central hole in the pole core.

14. The rotor as claimed in claim 9, wherein the pole core is formed of two or more core parts.

15. The rotor as claimed in claim 14, wherein the core parts are integral.

16. The rotor as claimed in claim 15, wherein the central internal area is a central hole in the pole core.
